(19) United States
(12) Patent Application Publication
(10) Pub. No.: US 2011/0086293 A1
(43) Pub. Date: Apr. 14, 2011

(54) SOLID OXIDE FUEL CELL HOUSING

(76) Inventors: Sang-Jun Kong, Suwon-si (KR); Kyeong-Beom Cheong, Suwon-si (KR); Ki-Woon Kim, Suwon-si (KR); Duk-Hyoung Yoon, Suwon-si (KR); Tae-Ho Kwon, Suwon-si (KR)

(21) Appl. No.: 12/696,331

(22) Filed: Jan. 29, 2010

Related U.S. Application Data
(60) Provisional application No. 61/251,468, filed on Oct. 14, 2009.

(51) Int. Cl. H01M 8/02

(52) U.S. Cl. 429/513

(57) ABSTRACT

A housing for a solid oxide fuel cell, the housing including a plurality of side walls defining a cavity; a first opening in one of the plurality of side walls, the first opening being configured to allow fluid to enter into the cavity; a second opening in one of the plurality of side walls, the second opening being configured to allow the fluid to exit from the cavity; and a flow path extending unit between the first opening and the second opening to increase a length of a flow path between the first opening and the second opening.

### CROSS-REFERENCE TO RELATED APPLICATION

This application claims the benefit of U.S. Provisional Patent Application Ser. No. 61/251,468, filed Oct. 14, 2009 and entitled SOFC housing and solid oxide fuel cell housing the same, the entire content of which is hereby expressly incorporated by reference.

### BACKGROUND

1. Field

An aspect of the present invention relates to a solid oxide fuel cell (SOFC), and more particularly to a housing for an SOFC.

2. Description of the Related Art

SOFCs have advantages of producing little to no pollution, high-efficiency generation and the like. SOFCs are typically applied to static generation systems, small independent power sources, automotive power sources and the like.

Currently, SOFC stacks are broadly divided into a cylindrical type, an integral type and a planar type in accordance with their shapes. Each of the types has unique advantages and disadvantages. Among them, the cylindrical type SOFC has advantages in that gas sealing is not required and its mechanical strength is excellent.

### SUMMARY

In one embodiment, there is provided a SOFC housing in which a uniform amount of fluid can be substantially flowed around a plurality of SOFC cells, e.g., anode supported cylindrical SOFC cells.

In another embodiment, there is provided an SOFC having an SOFC housing which can improve performance of a stack or system and perform stable operation for a long period of time.

According to an aspect of the present invention, a housing for a solid oxide fuel cell is provided, the housing including a plurality of side walls defining a cavity; a first opening in one of the plurality of side walls, the first opening being configured to allow fluid to enter into the cavity; a second opening in one of the plurality of side walls, the second opening being configured to allow the fluid to exit from the cavity; and a flow path extending unit between the first opening and the second opening to increase a length of a flow path between the first opening and the second opening.

In one embodiment, the flow path has a zigzag shape between a first side wall of the side walls and a second side wall of the side walls. Further, the flow path extending unit may include a first partition wall attached to and extending from the first side wall in a direction toward the second side wall and a second partition wall attached to and extending from the second side wall in a direction toward the first side wall, wherein the first partition wall is spaced from the second partition wall in a direction perpendicular to the partition walls.

In one embodiment, a perforated plate in is the cavity, wherein the perforated plate has a plurality of openings configured to allow the fluid to flow therethrough. Further, the perforated plate may be oriented substantially perpendicular to the second partition wall and wherein the perforated plate is adjacent to the outlet side of the flow path extending unit. Additionally, the diameters of the plurality of openings of the perforated plate may vary with increasing distance of the plurality of openings from the outlet side of the flow path extending unit. For example, the diameters of the plurality of openings may increase or decrease along the length of the flow path. In one embodiment, the plurality of openings are configured to provide a substantially uniform flow of fluid in the cavity. Further, a distance between adjacent ones of the plurality of openings of the perforated plate may vary along the length of the flow path.

The housing of claim 4, further comprising a plurality of guide tubes, wherein each of the plurality of guide tubes is coupled to a respective one of the plurality of openings of the perforated plate.

In one embodiment, the housing may include a blocking unit adjacent to the first opening, wherein the blocking unit is configured to divert fluid flowing through the first opening into the flow path, and the blocking unit may be spaced from the first opening. Further, the second opening may include a slot in a lower portion of the one of the side walls or a plurality of openings in the one of the side walls.

In accordance with aspects of the present invention, a solid oxide fuel cell is provided including a housing; a plurality of solid oxide fuel cell cells housed within the housing; a fuel supply unit for supplying fuel to the plurality of solid oxide fuel cells; an oxidizer supply unit for supplying an oxidizer to the plurality of solid oxide fuel cells; wherein the housing includes a plurality of side walls defining a cavity; a first opening in one of the plurality of side walls, the first opening being configured to allow fluid to enter into the cavity; a second opening in one of the plurality of side walls, the second opening being configured to allow the fluid to exit from the cavity; and a flow path extending unit between the first opening and the second opening to increase a length of a flow path between the first opening and the second opening.

### BRIEF DESCRIPTION OF THE DRAWINGS

The accompanying drawings, together with the specification, illustrate exemplary embodiments of the present invention, and, together with the description, serve to explain the principles of the present invention.

FIG. 1 is a schematic perspective view of an SOFC housing according to an embodiment of the present invention.

FIG. 2 is a schematic perspective view of an SOFC illustrating the flow of a fluid in the SOFC housing of FIG. 1.

FIG. 3 is a schematic perspective view of an SOFC housing according to another embodiment of the present invention.

FIG. 4 is a schematic perspective view of an SOFC illustrating the flow of a fluid in the SOFC housing of FIG. 3.

FIG. 5 is a schematic perspective view illustrating the flow of a fluid in an SOFC housing according to a comparative example.

FIGS. 6A to 6C are graphs illustrating flow velocities of a fluid passing through three planes in the SOFC housing of FIG. 5, respectively.

FIG. 7 is a schematic perspective view of an SOFC housing according to still another embodiment of the present invention.

FIG. 8 is a schematic perspective view of an SOFC housing according to still another embodiment of the present invention.

FIG. 9 is a schematic sectional view of an SOFC illustrating the flow of a fluid in the SOFC housing of FIG. 8.

FIG. 10 is a cross-sectional view of the SOFC of FIG. 9.

FIGS. 11A to 11C are graphs illustrating flow velocities of a fluid passing through three planes in the SOFC housing of FIG. 10, respectively.

FIGS. 12A and 12B are schematic sectional views illustrating the structures of perforated plates and guide tubes available for the SOFC housing according to an embodiment of the present invention.

FIG. 13A is a schematic sectional view illustrating the operation of an SOFC cell available for the SOFC according to an embodiment of the present invention.

FIG. 13B is a schematic perspective view illustrating the shape of another SOFC cell substituted for the SOFC cell of FIG. 13.

### EXPLANATION OF REFERENCE NUMERALS FOR MAJOR PORTIONS SHOWN IN DRAWINGS

100, 200, 300, 300a: Housing

101, 201, 301: Solid oxide fuel cell

110, 210, 310: Housing body

120, 220, 320: Flow path extending unit

227, 340, 340a, 340b: Perforated plate

330: Blocking unit

350, 350a, 350b, 350c: Guide tube

200, 200a: Cell

### DETAILED DESCRIPTION

Hereinafter, exemplary embodiments of the present invention will be described in detail with reference to the accompanying drawings so that they can be readily implemented by those skilled in the art.

For clarity, where the function and constitution are well-known in the relevant arts, further discussion will not be presented in the detailed description of the present invention. In the drawings, like numbers refer to like elements throughout. Also, the thicknesses or sizes of layers or regions are exaggerated for the convenience of description and clarity. For convenience of illustration, elements are appropriately projected in the drawings.

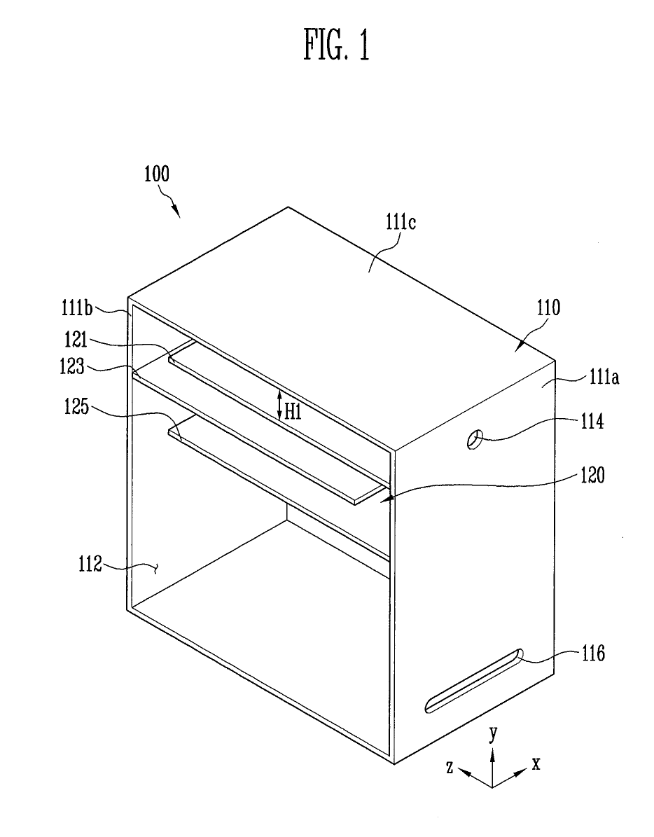

FIG. 1 is a schematic perspective view of an SOFC housing according to an embodiment of the present invention.

Referring to FIG. 1, the SOFC housing 100 includes a housing body 110 and a flow path extending unit 120 coupled to the housing body 110. The housing body 110 is provided with an internal space or cavity 112, at least one first opening 114 connected to the cavity 112 to allow a fluid to flow into the cavity 112 therethrough, and at least one second opening 116 connected to the cavity 112 to allow the fluid to flow out from the cavity 112 therethrough. The flow path extending unit 120 is disposed adjacent to the first opening 114 so that the fluid flowing into the cavity 112 through the first opening 114 flows in a generally zigzag form within the housing body 110.

The sectional area of the first opening 114 is significantly smaller than an area of the cavity 112 (corresponding to the x-y plane) in which the fluid flowing into the cavity 112 through the first opening 114 flows. In this case, in order to allow the fluid flowing into the cavity 112 through the first opening 114 to flow uniformly within the cavity 112, the fluid is substantially one-dimensionally distributed rather than two-dimensionally distributed in a portion corresponding to the first opening 114. Therefore, in this embodiment, the fluid is substantially one-dimensionally distributed through the flow path extending unit 120 connected to the first opening 114 so that the fluid can flow into the flow path extending unit 120 through the first opening 114.

In one embodiment, the flow path extending unit 120 may have a flow path structure formed with multistage screens or partition walls. More specifically, the flow path extending unit 120 has a flow path structure in which planar first and second partition walls 121 and 123 are disposed to extend in opposite directions while being spaced from each other at a predetermined interval. Here, one end of the first partition wall 121 is connected to a first wall 111a of the housing body 110 between the first wall 111a and a second wall 111b formed opposite to the first wall 111a, and one end of the second partition wall 123 is connected to the second wall 111b of the housing body 110. Such a structure may be referred to as an interdigitated structure.

In this embodiment, since the first and second openings 114 and 116 are provided at upper and lower portions of the first wall 111a, respectively, the flow path extending unit 120 is provided with a third partition wall 125 oriented similar to the first partition wall 121, but spaced from the first and second partition walls 121 and 123 so that the fluid flowing into the flow path extending unit 120 through the first opening 114 smoothly flows out through the second opening 116 via the flow path extending unit 120. More specifically, the planar third partition wall 125 has one end connected to the first wall 111a and is disposed to be spaced from the second partition wall 123 at a predetermined interval.

The flow path extending unit 120 has a generally zigzag or meandering form. Such a flow path structure is designed in consideration of the limits of the volume of the SOFC housing 100. For example, the flow path structure is designed so that the volume of the SOFC housing 100 is not substantially increased or is minimally increased.

In this embodiment, considering an effective flow path extending structure, the flow path extending unit 120 is provided so that the fluid flowing into the cavity 112 through the first opening 114 first flows between an inner surface of an upper wall 111c of the housing body 110 and an outer surface of the flow path extending unit 120, i.e., one surface of the first partition wall 121. In the following description, the flow path extending unit 120 may include a path between the inner surface of the upper wall 111c of the housing body 110 and the outer surface of the flow path extending unit 120, in view of the flow path extension.

In the flow path extending unit 120, the sectional area of a flow path in a direction approximately perpendicular to the flow direction (the z-direction) of the fluid is considerably smaller than the volume of the cavity 112. For example, the distance H1 between the upper wall 111c of the housing body 110 and the first partition wall 121 is similar to or smaller than the diameter of the first opening 114.

In the flow path extending unit 120, the width of the flow path (the x-direction) in a direction approximately perpendicular to the flow direction (the z-direction) of the fluid is larger than the diameter of the first opening 114. For example, the width of the flow path may be approximately a few times to a few tens times larger than the diameter of the first opening 114. However, the width of the flow path has a considerably smaller value than the length of the flow path of the flow path extending unit 120. The one-dimensional flow path structure is formed through the relationship between the length and width of the flow path.

The flow path of the flow path extending unit 120 may be extended as much as the length and number of partition walls are increased. Here, the first and second partition walls 121 and 123 are disposed to form a generally zigzag flow path. In this embodiment, distances in the direction between adjacent partition walls (the y-direction) may be identical.

According to the aforementioned configuration, the flow path extending unit 120 substantially prevents the flow flowing into the housing 100 through the first opening 114 from being substantially distributed with vector components two-dimensionally from each other. The flow path extending unit 120 allows the unequal velocity of the fluid flowing through the first opening 114 to be substantially unified through the one-dimensional flow path structure.

That is, the flow path extending unit 120 allows the fluid flowing from at least one point to one-dimensionally flow through a flow path having a sufficient length. Accordingly, velocity components of the fluid passing through the flow path extending unit 120 are substantially unified so that the fluid can flow at an almost uniform velocity in the cavity 112 of the SOFC housing 100. In this embodiment, the fluid flows due to the entire difference in pressure within the SOFC housing 100.

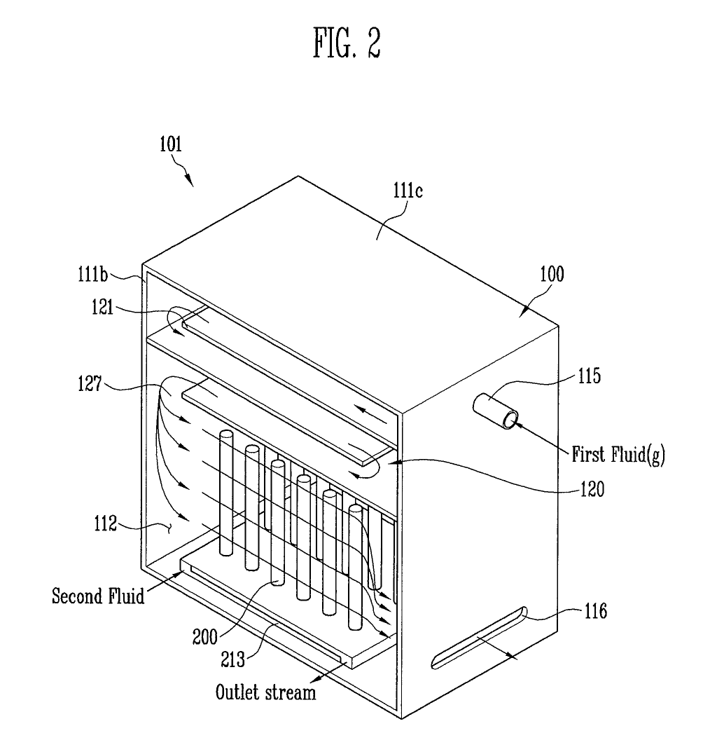

FIG. 2 is a schematic perspective view of an SOFC illustrating the flow of a fluid in the SOFC housing of FIG. 1.

Referring to FIG. 2, the SOFC 101 includes the SOFC housing (hereinafter, referred to as the housing) of this embodiment, SOFC cells 200 (hereinafter, referred to as cells) mounted in the housing 100, and a reactant supply unit for supplying a fuel and an oxidizer to the cells 200.

The reactant supply unit may include a fuel supply unit and an oxidizer supply unit. The fuel or oxidizer supply unit may include a manifold connected to the cells 200. In the following description, for convenience of illustration, a gaseous first fluid supplied through the flow path extending unit 120 in the housing 100 is used as the oxidizer, and a second fluid supplied through a manifold 210 is used as the fuel. Here, the manifold 210 is coupled to the housing 100 and connected to the cells 200 so that a fluid can flow therethrough. Examples of the oxidizer may include air, pure oxygen gas and the like, and examples of the fuel may include hydrogen, coal gas, natural gas, landfill gas and the like.

In this embodiment, the oxidizer supply unit supplies air to the housing 100 through a pipe 115 connected to the first opening 114. In this case, the air flowing into the housing 100 first flows between the upper wall 111c of the housing 100 and the first partition wall 121 and then changes its direction on an inner surface of the second wall 111b to flow between the first partition wall 121 and the second partition wall 123. The air again changes its direction on an inner surface of the first wall 111a to flow between the second partition wall 123 and the third partition wall 125. Subsequently, the air again changes its direction and then passes around the cells the cells 200 housed in a predetermined orientation within the cavity 112. Then, the air is discharged from the housing 100 through the second opening 116.

In the aforementioned flow of air, the air supplied through the pipe 115 under a predetermined pressure substantially one-dimensionally flows along the flow path which has a length sufficiently longer than the width of the flow path extending unit 120. The air is supplied to the cavity 112 of the housing in the state such that vector components are substantially unified. The air supplied to the cavity 112 of the housing 100 flows around the cells 200 at a substantially uniform flow velocity and is then discharged from the housing 100 through the second opening 116.

According to the aforementioned configuration, the SOFC 101 can effectively generate electricity through an electrochemical reaction of the oxidizer uniformly supplied to a cathode of each of the cells 200 and the fuel supplied to an anode of each of the cells 200 through the manifold 210. The manifold 210 can discharge a reaction byproduct such as water and an unused fuel through an outlet stream.

As described above, in the SOFC 101 of this embodiment, an oxidizer with a substantially uniform flow velocity is supplied around the cells 200 through the flow path extending unit 120. Accordingly, assuming that the amount of fuel supplied to each of the cells 200 is substantially uniform, the performance of the SOFC 101 can be improved, and the SOFC 101 can be stably operated for a long period of time.

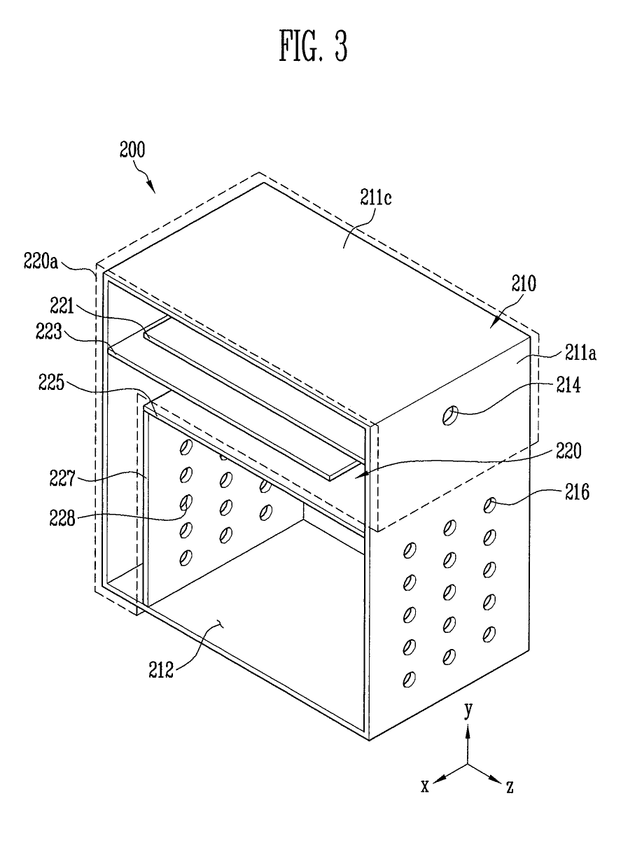

FIG. 3 is a schematic perspective view of an SOFC housing according to another embodiment of the present invention.

Referring to FIG. 3, the SOFC housing 203 includes a housing body 210, a flow path extending unit 220 coupled to the housing body 210, and a perforated plate 227 coupled to the flow path extending unit 220 at a downstream side of the flow direction of a fluid.

The housing body 210 is provided with a cavity 212 and first and second openings 214 and 216 connected to the cavity 212 so that the fluid can flow therethrough. The housing body 210 is provided with a first wall 211a. The first and second openings 214 and 216 are spaced by a predetermined interval on the first wall 211a. In this embodiment, the second opening 216 includes a plurality of openings.

In this embodiment, the housing body 210 may accommodate the flow path extending unit 220. However, the present invention is not limited thereto. For example, the flow path extending unit 220 may be designed to have an upper wall 211c of the housing body 210 and to cover an upper opening of the housing body 210. Alternatively, the flow path extending unit 220 may be designed to have a portion 220a designated by the dotted line, allowing the housing body 210 to be formed separate from the portion 220a.

The flow path extending unit 220 is provided so that air supplied through the first opening 214 under a predetermined pressure substantially one-dimensionally flows through a flow path having a length sufficiently longer than a width of the flow path. The flow path extending unit 220 is provided with a first partition wall 221, a second partition wall 223 and a third partition wall 225. The flow path extending unit 220 is substantially identical to the flow path extending unit 120 of FIG. 1.

The perforated plate 227 is positioned at one end of the flow path to be opposite to the first opening 214 positioned at the other end of the flow path with respect to the flow path of the flow path extending unit 220. The perforated plate 227 is provided to allow the fluid discharged from an outlet of the flow path extending unit 220 to be appropriately distributed. As such, the perforated plate 227 is provided with a plurality of openings 228 so that the fluid is appropriately distributed.

In this embodiment, the perforated plate 227 is provided so that the planar first partition wall 225 extends in a second direction (the y-direction) perpendicular to the planar first partition wall 225 extending in a first direction (the z-direction). That is, the perforated plate 227 is provided parallel with the x-y plane so as to be perpendicular to the planar first partition wall 225 parallel with the x-z plane.

Considering the relationship between a guide tube and a perforated plate described below, the size of the perforated plate may be proportional to that of the guide tube. For example, the plurality of openings 228 may be designed so that the size of first openings positioned at a first portion 229a of the perforated plate 227 at which the fluid passing through the flow path extending unit 220 first encounters is smaller than that of second openings positioned at a second portion 229b of the perforated plate 227 positioned in contact with the first portion 229a. Alternatively or additionally, the plurality of openings 228 may be designed so that the interval between adjacent first openings positioned at the first portion 229a of the perforated plate 227 is larger than that between adjacent second openings positioned at the second portion 229b of the perforated plate 227 positioned in contact with the first portion 229a.

According to the aforementioned configuration, the fluid can be discharged to the cavity 212 of the housing 210 by allowing the fluid flowing into the housing 210 through the first opening 214 to flow substantially one-dimensionally and then appropriately distributed.

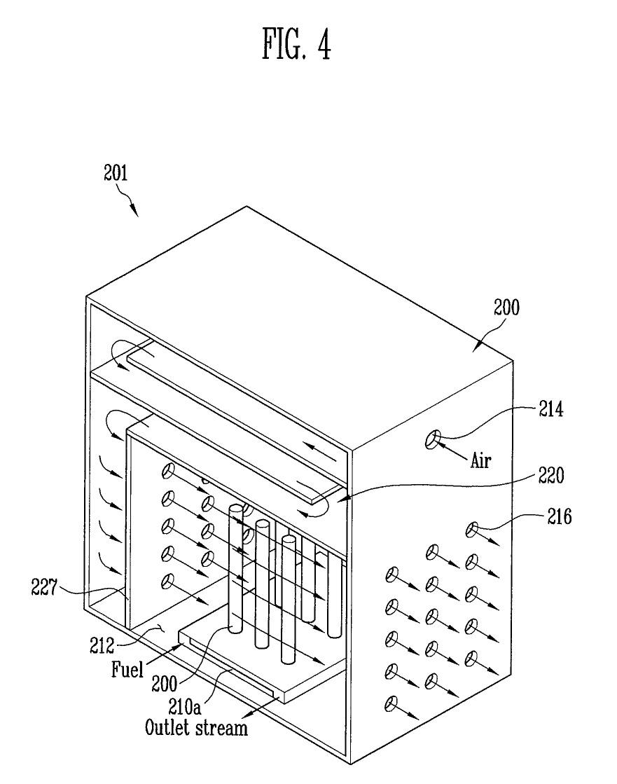

FIG. 4 is a schematic perspective view of an SOFC illustrating the flow of a fluid in the SOFC housing of FIG. 3.

As illustrated in FIG. 4, the SOFC 201 includes the housing 203 of this embodiment, a plurality of cells 202 accommodated in the housing 203, an oxidizer supply unit for supplying air to each of the cells through a predetermined flow path in the housing 203, and a fuel supply unit for supplying a fuel to each of the cells 200. The fuel supply unit includes a manifold 210a connected to the plurality of cells 200 so that a fluid can flow therethrough.

In this embodiment, the oxidizer supply unit supplies air to the housing 203 through the first opening 214. The air flowing into the housing 203 passes through the flow path extending unit 220 and is then distributed into the cavity 212 through the perforated plate 227. The air distributed into the cavity 212 passes around the plurality of cells 200 and is then discharged to the exterior of the housing 203 through the second openings 216.

According to the aforementioned configuration, the SOFC 201 can effectively generate electricity through an electrochemical reaction of oxygen substantially uniformly supplied to a cathode positioned on an outer surface of each of the cells 200 and a fuel supplied to an anode positioned at an inner surface of each of the cells 200 through the manifold 210a. The manifold 210a can discharge a reaction byproduct such as water and unused fuel to the exterior of the housing 203 through an outlet stream.

As described above, in the SOFC 201 of this embodiment, air with a substantially uniform flow velocity is supplied around the cells 200 through the flow path extending unit 220 and the perforated plate 227. Accordingly, assuming that the amount of fuel supplied to each of the cells 200 is substantially uniform, the performance of the SOFC 201 can be improved, and the SOFC 201 can be stably operated for a long period of time.

FIG. 5 is a schematic perspective view illustrating the flow of a fluid in an SOFC housing according to a comparative example.

In the comparative example, a plurality of cells are mounted in a housing without a flow path extending unit of the housing of FIG. 1, and the flow velocities of air supplied into the housing are measured.

As illustrated in FIG. 5, the SOFC 102 according to the comparative example includes a housing 103 and a plurality of cells 200 accommodated in the housing 103.

The housing 103 is provided with a first wall 104a, a second wall 104b, a first opening 105 formed on the first wall 104a, and a second opening 106 formed on the second wall 104b. The housing 103 has a structure substantially identical to that of the housing of FIG. 1 except for the flow path extending unit described above. Further, the housing 103 has the volume of a cavity 103a substantially identical to that of the housing 100 of FIG. 2. The plurality of cells 200 are mounted in the housing 103. Here, the number and stacked/arranged form of the cells 200 are identical to those of the cells 200 of FIG. 2.

Although schematically shown in FIG. 5, in this comparative example, a total of 54 cells are used as the plurality of the cells 200. Here, the cells constitute 6 lines in the flow direction (the z-direction) of air and 9 lines in the y-direction.

The air flowing into the housing 103 through the first opening 105 is distributed with unequal vector components in the cavity 103a. The vector components of the air distributed into the cavity 103a from the first opening 105 may be shown as a plurality of arrows 108, based on a predetermined plane 107 spaced from the first wall 104a at a predetermined interval.

As described above, the air flowed into the housing 103 of the SOFC 102 of the comparative example under a predetermined pressure is two-dimensionally distributed on a plane corresponding to the plane 107 from a portion corresponding to the first opening 105, so that the velocity distribution of the air is unequal.

That is, in the housing or SOFC of the comparative example, while the air flows from the first opening 105 to the second opening 106 via the cavity 103a, the velocities of the air in front, middle and rear portions of the cavity 103a; and bottom, center and top portions of the cavity 103a are considerably different due to the unequal velocity distribution of the air and the wall effect such as vector components of the air reflected from an inner surface of the housing 103.

The front, middle and rear portions of the cavity 103a correspond to x-y planes at first, second and third points 109a, 109b and 109c, respectively.

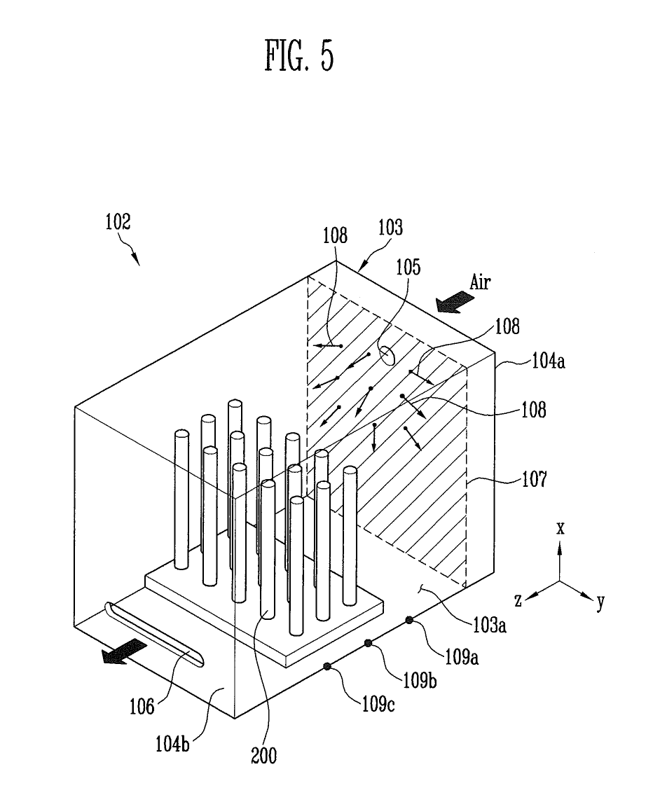

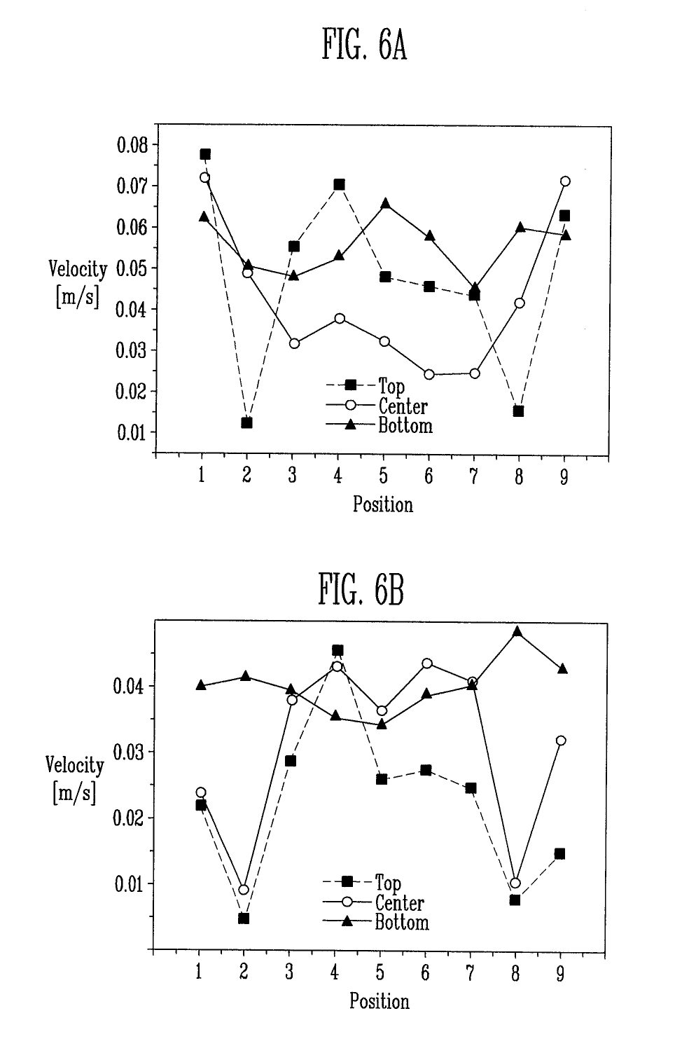

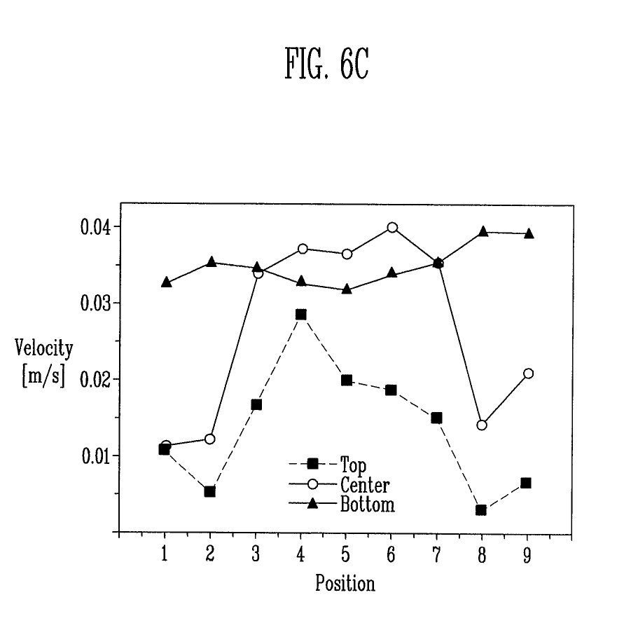

FIGS. 6A to 6C are graphs illustrating flow velocities of a fluid passing through three planes in the SOFC housing of FIG. 5, respectively. Here, the three planes correspond to the front, middle and rear portions of FIG. 5, respectively.

FIG. 6A illustrates results obtained by measuring flow velocities of the air at top, center and bottom portions around each of the cells on first horizontal line in the front portion. As illustrated in FIG. 6A, the velocities of the air at bottom portions around respective nine cells in the front portion were measured from about 0.046 m/s to about 0.066 m/s, the velocities of the air at center portions around the respective nine cells in the front portion were measured from about 0.025 m/s to about 0.071 m/s, and the velocities of the air at top portions around the respective nine cells from the front portion were measured from about 0.011 m/s to about 0.078 m/s.

FIG. 6B illustrates results obtained by measuring flow velocities of the air at top, center and bottom portions between adjacent cells on third and fourth lines in the middle portion. As illustrated in FIG. 6B, the velocities of the air at bottom portions between nine pairs of adjacent cells in the middle portion were measured from about 0.033 m/s to about 0.046 m/s, the velocities of the air at center portions between the nine pairs of adjacent cells in the middle portion were measured from about 0.010 m/s to about 0.041 m/s, and the velocities of the air at top portions between the nine pairs of adjacent cells in the middle portion were measured from about 0.006 m/s to about 0.043 m/s.

FIG. 6C illustrates results obtained by measuring flow velocities of the air at top, center and bottom portions around each of the cells on a sixth line in the rear portion. As illustrated in FIG. 6C, the velocities of the air at bottom portions around the respective nine cells in the rear portion were measured from about 0.032 m/s to about 0.040 m/s, the velocities of the air at center portions around the respective nine cells in the rear portion were measured from about 0.013 m/s to about 0.040 m/s, and the velocities of the air at top portions around the respective nine cells from the rear portion were measured from about 0.005 m/s to about 0.030 m/s.

In the SOFC 102 of the comparative example, the velocity of the air in the housing showed a large difference depending on a position of each of the cells, and its deviation showed up to the maximum of about 50%. As such, it can be seen that the SOFC 102 of the comparative example has substantially unequal velocities of the air at all the positions of the cavity 103a of the housing 103.

According to this comparative example, in the SOFC 102, although it is assumed that a fuel supplied to each of the cells 200 is equal, oxygen in the air supplied to each of the cells 200 is unequal. Hence, performance of the respective cells 200 are remarkably different. Therefore, performance of a system may be lowered, and it may be difficult to operate the system for a long period of time.

In another comparative example, velocities of air flowing into a cavity of a housing excluding the flow path extending unit from the housing in the SOFC of FIG. 4 were measured. The result was almost no different from that of the aforementioned comparative example. The velocities of the air in the housing of the SOFC according to the comparative example will not be separately described so as to avoid repetition of description.

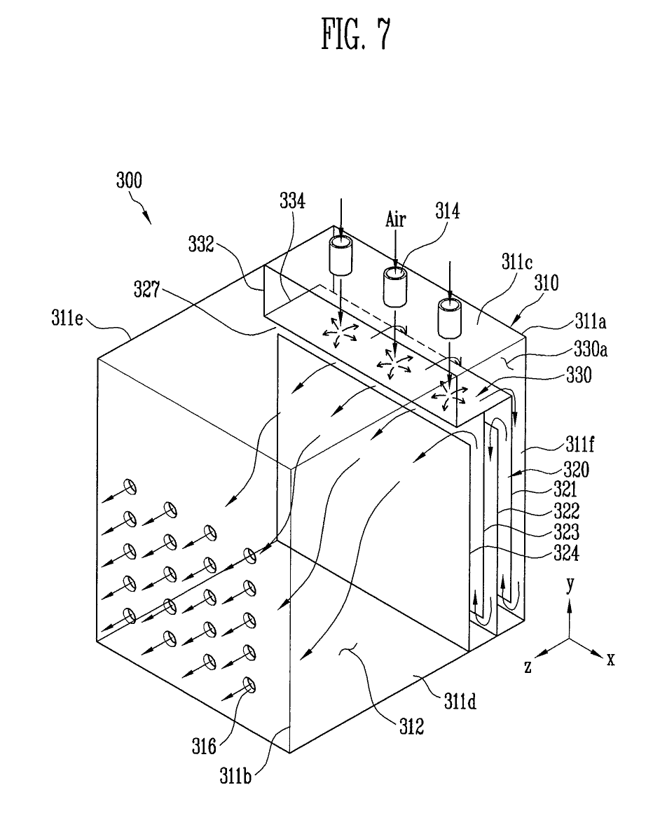

FIG. 7 is a schematic perspective view of an SOFC housing according to still another embodiment of the present invention.

Referring to FIG. 7, the housing 300 includes a housing body 310, a flow path extending unit 320 coupled to the housing body 310, and a blocking unit 330.

The housing body 310 is provided with a first wall 311a, a second wall 311b opposite to the first wall 311a and spaced therefrom by a predetermined interval, a third wall 311c connected to tops of the first and second walls 311a and 311b to each other, a fourth wall 311d opposite to the third wall 311c connected to bottoms of the first and second walls 311a and 311b, a fifth wall 311e connected to one edge of the first to fourth walls 311a to 311d, and a sixth wall 311f opposite to the fifth wall 311e connected to the another edge of the first to fourth walls 311a to 311d.

The housing body 310 is further provided with a cavity 312, a plurality of first openings 314 connected to the cavity 312 so that a fluid can flow therethrough, and a plurality of second openings 316 connected to the cavity 312 so that the fluid can flow therethrough. The plurality of first openings 314 are formed on the third wall 311c corresponding to an upper wall of the housing body 310, and the plurality of second openings 316 are formed on the second wall 311b.

In this embodiment, the three first openings 314 are disposed in a line and spaced at a predetermined interval in a direction parallel with the first wall 311a. The plurality of second openings 316 are disposed in a predetermined pattern on the second wall 311b.

The blocking unit 330 is disposed in the housing body 310 while being spaced from the three first openings 314 at a predetermined interval. If the blocking unit 330 is provided to be spaced from the three first openings 314 at the predetermined interval, air flowing into the housing body 310 through the first openings 314 bumps against the blocking unit 330 and is then appropriately distributed. In this embodiment, the blocking unit 330 is provided with a first blocking wall 332 extending by a predetermined length inside the housing body 310 from the third wall 311c, and a second blocking wall 334 extending toward the first wall 311a from an end edge of the first blocking wall 332. An end edge of the second blocking wall 334 is spaced from the first wall 311a at a predetermined interval.

In one embodiment, the blocking unit 330 may be formed as one outer surface of the flow path extending unit 320 fixed inside the housing body 310. In this case, the first blocking wall 332 becomes an internal partition wall for allowing the flow path extending unit 320 to be fixedly connected thereto in the housing body 310. The second blocking wall 334 becomes one wall of the flow path extending unit 320, and its outer surface serves as the blocking unit 330.

The flow path extending unit 320 has a flow path having a length that is sufficiently longer than its width (the x-direction). The flow path structure of the flow path extending unit 320 is formed so that the air distributed from the blocking unit 330 can flow substantially one-dimensionally. In this embodiment, the flow path extending unit 320 is provided with planar first, second, third and fourth partition walls 321, 322, 323 and 324 disposed in an interdigitated form and spaced by a predetermined interval. The third and fourth partition walls 323 and 324 are similarly oriented to the first and second partition walls 321 and 322, respectively.

The first partition wall 321 extends toward the fourth wall 311d from the end edge of the second blocking wall 334, and an end of the first partition wall 321 is spaced from the fourth wall 311d by a predetermined interval in the y-direction. The second partition wall 322 extends toward the second blocking wall 334 from the fourth wall 311d, and an end of the second partition wall 322 is spaced from the second blocking wall 334 by a predetermined interval. The third partition wall 323 extends toward the fourth wall 311d from a middle portion of the second blocking wall 334, and an end of the third partition wall 323 is spaced from the fourth wall 311d by a predetermined interval. The fourth partition wall 324 extends toward the second blocking wall 334 from the fourth wall 311d, and an end of the fourth partition wall 324 is spaced from the second blocking wall 334 by a predetermined interval.

The first, second, third and fourth partition walls 321, 322, 323 and 324 are spaced from their adjacent partition walls by a predetermined interval. Both sides of each of the first to fourth partition walls 321, 322, 323 and 324 are connected to the fifth and sixth walls 311e and 311f, respectively.

According to the aforementioned structure, the air flowing into the housing 300 through the first openings 314 bumps against the blocking unit 330 and is then distributed appropriately into a distribution space 330a between the blocking unit 330 and the first openings 314 or between the blocking unit 330 and the inner surface of the third wall 311c. The air distributed into the distribution space 330a naturally flows into the space between the flow path extending unit 320 and the first wall 311a. Then, the air one-dimensionally flows into the space between the flow path extending unit 320 and the first wall 311a, and the flow path of the flow path extending unit 320. At this time, vector components of the air are substantially unified. The air discharged from an outlet 327 of the flow path extending unit 320 passes through the cavity 312 at a substantially uniform velocity and is then discharged to the outside of the housing 300 through the second openings 316.

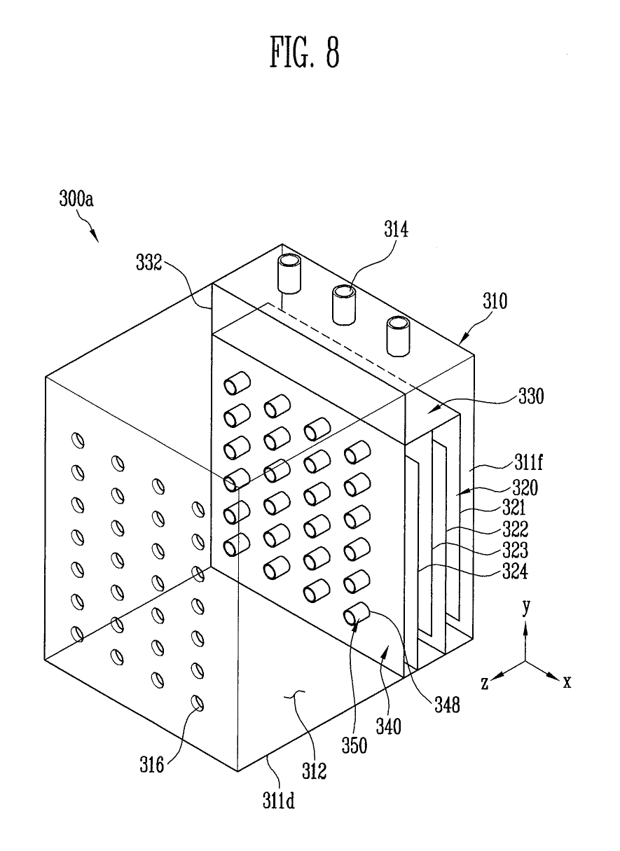

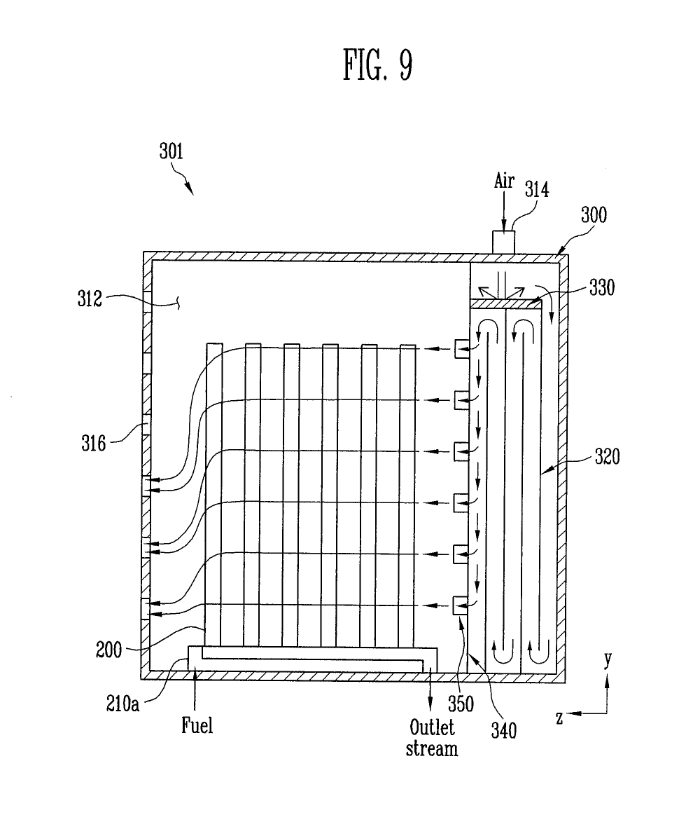

FIG. 8 is a schematic perspective view of an SOFC housing according to still another embodiment of the present invention. FIG. 9 is a schematic sectional view of an SOFC for illustrating the flow of a fluid in the SOFC housing of FIG. 8. FIG. 10 is a cross-sectional view of the SOFC of FIG. 9.

Referring to FIG. 8, the housing 300a includes a housing body 310, a flow path extending unit 320, a blocking unit 330, a perforated plate 340 and a plurality of guide tubes 350.

The housing 300a of this embodiment is substantially identical to the housing 300 described with reference to FIG. 7, except for the perforated plate 340 and the guide tubes 350.

The perforated plate 340 is disposed between a first blocking wall 332 and a fourth wall 311d corresponding to a bottom wall of the housing body 310. The perforated plate 340 is disposed between a cavity 312 of the housing 300a and the flow path extending unit 320. The perforated plate 340 is provided with a plurality of openings 348 through which a fluid discharged from the flow path extending unit 320 passes. The guide tubes 350 are coupled to a respective one of the openings 348.

In this embodiment, the perforated plate 340 is substantially identical to the perforated plate 227 described with reference to FIG. 3, except for the installation position and size of the perforated plate 340.

The plurality of guide tubes 350 are respectively coupled to the openings 348 on one surface of the perforated plate 340 opposite to second openings 316. Each of the guide tubes 350 guides the flow of air so that vector components of the air discharged from the flow path extending unit 320 to the cavity 312 through the openings 348 of the perforated plate 340 are converted into a direction substantially parallel with the z-direction. The protruded length of the guide tubes 350 may be controlled depending on the flow or velocity of the fluid.

More specifically, the air discharged from the flow path extending unit 320 maintains a velocity vector to a certain degree. Therefore, when passing through the openings 348 of the perforated plate 340, the air does not flow in a direction (the z-direction) perpendicular to the perforated plate 340 but rather flows inclined to a certain degree toward the bottom of the housing 300a. In this case, a portion of the air passing through the perforated plate 340 may not flow through the second openings 316 but rather may circulate in the cavity 312.

However, as illustrated in FIG. 9, in the SOFC 301 having the housing 300a, the flow of the air passing through the perforated plate 340 is guided generally in the z-direction by the guide tubes 350, so that the flow of the air circulating only in the cavity 312 is removed, and accordingly, the flow of the air in the cavity 312 is substantially unified in the z-direction.

Flow of the air was measured in the cavity 312 of the SOFC 301 of this embodiment. As illustrated in FIG. 10, flow of the air was measured in front, middle and rear portions A1, A2 and A3 of a stack including a plurality of cells and top, center and bottom portions of each of the cells, respectively. In the stack, the plurality of cells are disposed in the flow direction of the air in a predetermined pattern, e.g., 6 horizontal lines and 9 vertical lines.

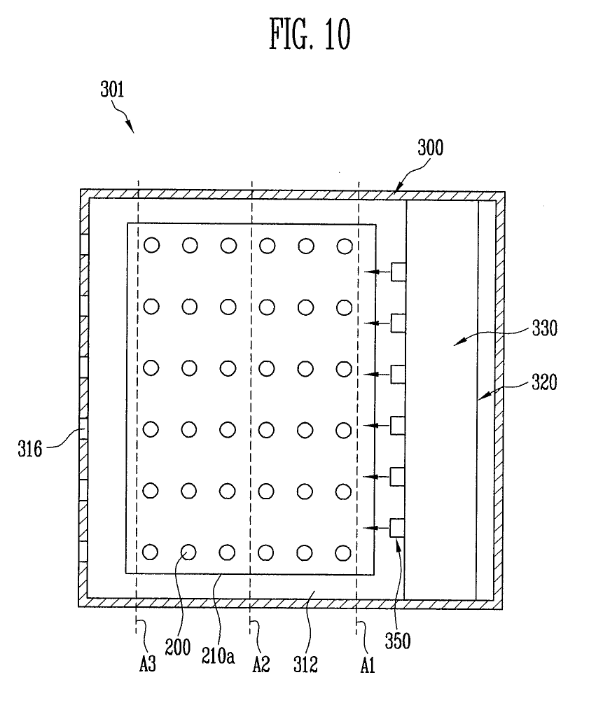

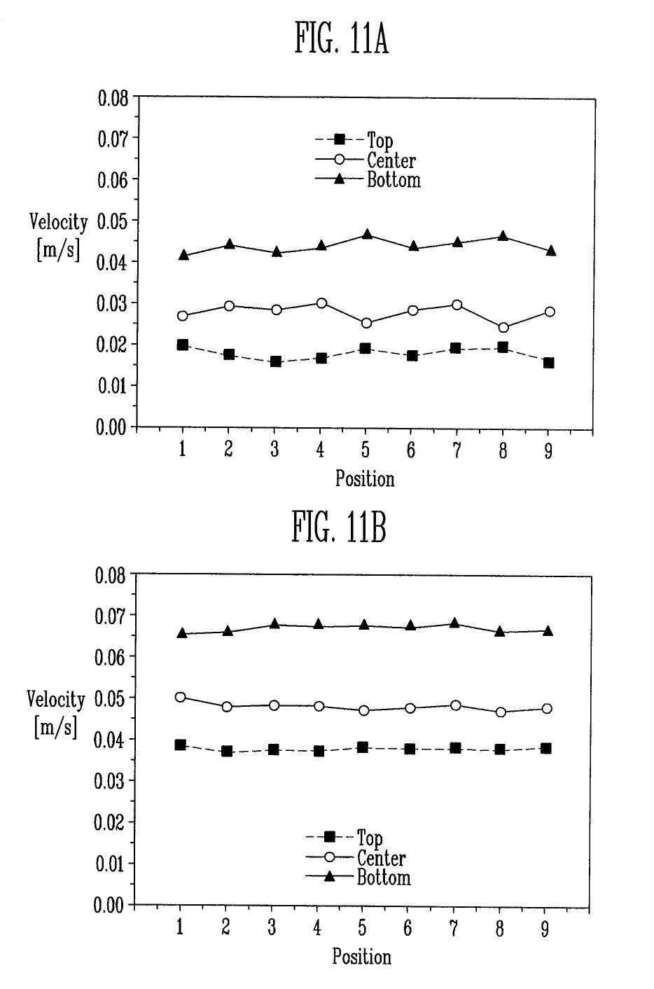

FIGS. 11A to 11C are graphs illustrating flow velocities of a fluid passing through three planes in the SOFC housing of FIG. 10, respectively.

FIG. 11A illustrates results obtained by measuring flow velocities of the air at top, center and bottom portions around each of the cells on first horizontal line in the front portion A1. As illustrated in FIG. 11A, the velocities of the air at bottom center and top portions around respective nine cells in the front portion A1 were about 0.045±0.003 m/s, about 0.025±0.005 m/s and about 0.017±0.0002 m/s, respectively.

FIG. 11B illustrates results obtained by measuring flow velocities of the air at top, center and bottom portions between adjacent cells on third and fourth lines in the middle portion A2. As illustrated in FIG. 11B, the velocities of the air at bottom, center and top portions between nine pairs of adjacent cells in the middle portion A2 were about 0.068±0.002 m/s, about 0.049±0.002 m/s and about 0.039±0.0001 m/s, respectively.

FIG. 11C illustrates results obtained by measuring flow velocities of the air at top, center and bottom portions around each of the cells on a sixth line in the rear portion A3. As illustrated in FIG. 11C, the velocities of the air at bottom, center and top portions around the respective nine cells in the rear portion A3 were about 0.068±0.002 m/s, about 0.045±0.001 m/s and about 0.037±0.0001 m/s, respectively.

According to this embodiment, the velocity distributions of the air at the top, center and bottom portions of the front portion A1 in the housing of the SOFC 301 had deviations of about 9.5%, about 7.5% and about 4.4%, respectively. A uniform deviation of about 1.3% to about 1.9% was shown at all the positions of the middle and rear portions A2 and A3. As such, in the SOFC 301 of this embodiment, it can be seen that the velocity distribution of the fluid for each position around the cells in the housing is considerably uniform.

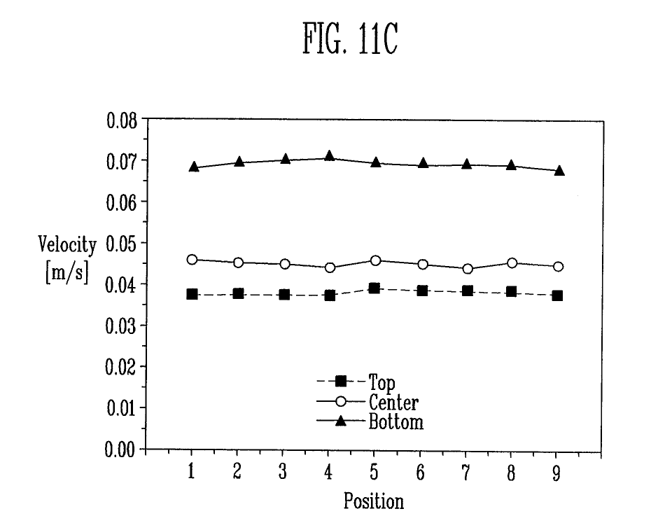

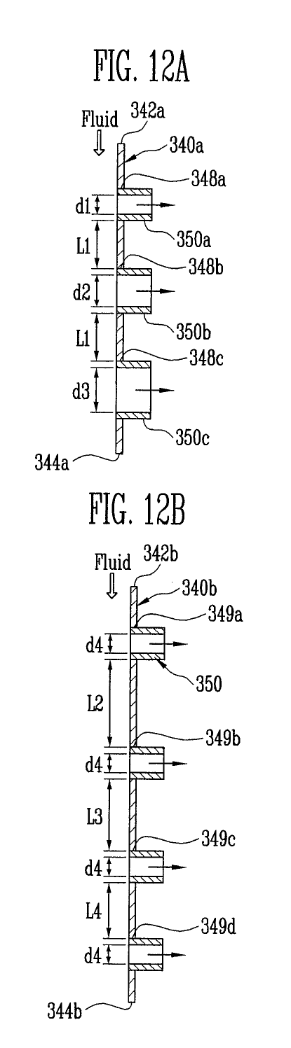

FIGS. 12A and 12B are schematic sectional views illustrating the structures of perforated plates and guide tubes, available for the SOFC housing of this embodiment.

This embodiment provides the structures of perforated plates and guide tubes applicable to the housings using the perforated plate or the perforated plate and guide tubes according to the aforementioned embodiments.

Referring to FIG. 12A, a perforated plate 340a is provided with a plurality of openings 348a, 348b and 348c. In this embodiment, the diameters of the openings 348a, 348b and 348c may be increased as the openings 348a, 348b and 348c become more distal from a side 342a of the perforated plate 340a at which a fluid first arrives and more proximal to a side 344a. That is, the perforated plate 340a may be provided so that the first diameter d1 of the first opening 348a is smaller than the second diameter d2 of the second opening 348b, and the second diameter d2 of the second opening 348b is smaller than the third diameter d3 of the third opening 348c. In this embodiment, distances L1 between adjacent openings may be identical.

When guide tubes 350a, 350b and 350c are coupled to the openings 348a, 348b and 348c of the perforated plate 340a, respectively, the sectional areas of hollow portions of the guide tubes 350a, 350b and 350c may be increased as the guide tubes 350a, 350b and 350c become more distal from a side 342a of the perforated plate 340a at which a fluid first arrives and more proximal to a side 344a.

Referring to FIG. 12B, a perforated plate 340b is provided with a plurality of openings 349a, 349b, 349c and 349d. In this embodiment, the intervals between adjacent openings may be decreased as the openings 349a, 349b and 349c become more distal from a side 342b of the perforated plate 340b at which a fluid first arrives and more proximal to a side 344b. That is, in the perforated plate 340b, the first interval L2 between the adjacent first and second openings 349a and 349b is greater than the second interval L3 between the adjacent second and third openings 349b and 349c. The second interval L3 between the adjacent second and third openings 349b and 349c is greater than the third interval L4 between the adjacent third and fourth openings 349c and 349d. In this embodiment, the diameters d4 of the respective openings may be constant.

Guide tubes 350 having the same sectional area of hollow portions may be coupled to the openings 349a, 349b, 349c and 349d of the perforated plate 340b, respectively. In this case, in the perforated plate 340b, the intervals between adjacent guide tubes 350 may be decreased as the guide tubes 350 become more distal from a side 342b of the perforated plate 340b at which a fluid first arrives and more proximal to a side 344b.

Hereinafter, the SOFC of this embodiment and its operation will be described in detail.

Referring back to FIG. 9, the SOFC 301 of this embodiment includes a plurality of cells 200, a fuel supply unit for supplying a fuel to each of the cells 200, an oxidizer supply unit for supplying an oxidizer to each of the cells 200, and a housing 310 for accommodating the plurality of cells 200. The fuel supply unit may include a manifold 210a. The oxidizer supply unit is connected to the first openings 314 through a connecting means such as a pipe so that a fluid can flow therethrough. The oxidizer supply unit may supply air under a predetermined pressure.

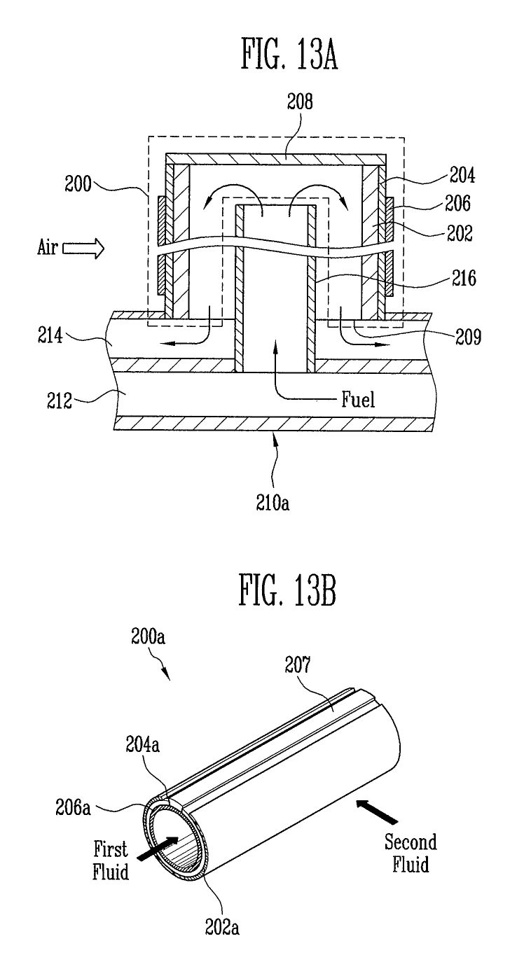

Specifically, as illustrated in FIG. 13A, a manifold 210a according to one embodiment has a two-layered structure and is provided to supply a fuel to a cell 200 through a fuel supply tube 216 connected to a first layer 212 so that the fluid can flow therethrough. The fuel supply tube 216 is deeply inserted into a hollow portion of the cell 200 while passing through a second layer 214, and the end potion of the fuel supply tube 216 is spaced from one cover 208 of the cell 200.

The cell 200 includes a tubular anode electrode 202 forming a support, and an electrolyte layer 204 and a cathode electrode 206 sequentially stacked on an outer surface of the anode electrode 202. The other end of the cell 200 is open and is connected to the second layer 214 of the manifold 210a so that the fluid can flow therethrough. In this embodiment, the cell 200 is provided with a structure having a closed end sealed by the cover 208, which may be referred to as a cap.

The fuel supplied into the cell 200 is supplied to the anode electrode 202 positioned on an inner surface of the cell 200 while flowing backward in the hollow portion of the cell 200 along the outer surface of the fuel supply tube 216. The cell 200 generates electricity through an electrochemical reaction of fuel and oxygen supplied to the anode and cathode electrodes 202 and 206. Here, the oxygen is contained in the air supplied through the oxidizer supply unit. The oxygen is uniformly supplied into the housing while passing through a flow path provided in the housing 310 of this embodiment. The non-reacted fuel and reaction byproducts discharged from the hollow portion of the cell 200 are discharged to the exterior of the manifold 210a through the second layer 214 of the manifold 210a.

In addition to the aforementioned structure, another structure may be used in the SOFC cell available for this embodiment.

For example, as illustrated in FIG. 13B, a cell 200a according to another embodiment may include a “sealless” cylindrical cell developed by Westinghouse (currently, Siemens-Westinghouse). In this case, manifolds may be disposed at both ends of the cell 200a.

The cell 200a includes a tubular cathode electrode 206a for forming a support, and an electrolyte layer 204a and an anode electrode 202a, subsequently stacked on an outer surface of the cathode electrode 206a. The cell 200a further includes a cathode interconnector 207 connected to the cathode electrode 206a while passing through the anode electrode 202a and the electrolyte layer 204a. The cathode interconnector 207 is spaced from the cathode electrode 206a at a predetermined interval while extending in a length direction of the cell 200a. The electrolyte layer 204a is formed of an ion conducting oxide for transporting oxygen ions or protons.

In the aforementioned embodiments, the cells have been described as anode and cathode supported cells. However, the cells of these embodiments may be formed as tubular SOFC cells using a separate support.

According to the aforementioned embodiments, an SOFC housing is provided in which a fluid flowing into the housing linearly flows along a flow path with a predetermined length so that a uniform flow of air flows around a plurality of SOFC cells.

Also, there can be provided an SOFC housing in which the fluid flowing into the housing is guided to linearly flow and then flow parallel with a direction perpendicular to a plane so that a more uniform flow of air flows around a plurality of SOFC cells.

Also, there can be provided an SOFC housing wherein the fluid flowing into the housing bumps and then linearly flows, or wherein linearly flowing fluid is distributed through a plurality of openings so that a more uniform flow of air flows around the plurality of SOFC cells, in addition to the aforementioned configuration.

Also, assuming that a substantially uniform flow of air is supplied around the respective SOFC cells, thereby supplying the same flow of fuel to each of the SOFC cells, the performances of the respective SOFC cells can be uniformly maintained or improved as compared with an SOFC stack or system having the same volume or specification. Moreover, since the difference in performances between the cells is decreased by the stable performances of the respective SOFC cells, an SOFC stack or system can be stably operated for a long period of time while improving the entire performance of the stack or system having combined SOFC cells.

While the present disclose has been described in connection with the above exemplary embodiments, it is to be understood that the present disclose is not limited to the embodiments and various modifications and equivalent arrangements can be included within the present disclose.

What is claimed is:

1. A housing for a solid oxide fuel cell, the housing comprising:
a plurality of side walls defining a cavity;
a first opening in one of the plurality of side walls, the first opening being configured to allow fluid to enter into the cavity;
a second opening in one of the plurality of side walls, the second opening being configured to allow the fluid to exit from the cavity; and
a flow path extending unit between the first opening and the second opening to increase a length of a flow path between the first opening and the second opening.

2. The housing of claim 1, wherein the flow path has a zigzag shape between a first side wall of the side walls and a second side wall of the side walls.

3. The housing of claim 2, wherein the flow path extending unit comprises a first partition wall attached to and extending from the first side wall in a direction toward the second side wall and a second partition wall attached to and extending from the second side wall in a direction toward the first side wall, wherein the first partition wall is spaced from the second partition wall in a direction perpendicular to the partition walls.

4. The housing of claim 2, further comprising a perforated plate in the cavity, wherein the perforated plate has a plurality of openings configured to allow the fluid to flow therethrough.

5. The housing of claim 4, wherein the perforated plate is oriented substantially perpendicular to the second partition wall and wherein the perforated plate is adjacent to the outlet side of the flow path extending unit.

6. The housing of claim 4, wherein the diameters of the plurality of openings of the perforated plate vary with increasing distance of the plurality of openings from the outlet side of the flow path extending unit.

7. The housing of claim 4, wherein the diameters of the plurality of openings increase or decrease along the length of the flow path.

8. The housing of claim 4, wherein the plurality of openings are configured to provide a substantially uniform flow of fluid in the cavity.

9. The housing of claim 4, wherein a distance between adjacent ones of the plurality of openings of the perforated plate varies along the length of the flow path.

10. The housing of claim 4, further comprising a plurality of guide tubes, wherein each of the plurality of guide tubes is coupled to a respective one of the plurality of openings of the perforated plate.

11. The housing of claim 1, further comprising a blocking unit adjacent to the first opening, wherein the blocking unit is configured to divert fluid flowing through the first opening into the flow path.

12. The housing of claim 11, wherein the blocking unit is spaced from the first opening.

13. The housing of claim 1, wherein the second opening comprises a slot in a lower portion of the one of the side walls or a plurality of openings in the one of the side walls.

14. A solid oxide fuel cell comprising:
a housing;
a plurality of solid oxide fuel cell cells housed within the housing;
a fuel supply unit for supplying fuel to the plurality of solid oxide fuel cells;
an oxidizer supply unit for supplying an oxidizer to the plurality of solid oxide fuel cells;
wherein the housing comprises:
a plurality of side walls defining a cavity;
a first opening in one of the plurality of side walls, the first opening being configured to allow fluid to enter into the cavity;
a second opening in one of the plurality of side walls, the second opening being configured to allow the fluid to exit from the cavity; and
a flow path extending unit between the first opening and the second opening to increase a length of a flow path between the first opening and the second opening.

15. The solid oxide fuel cell of claim 14, wherein the flow path has a zigzag shape between a first side wall of the side walls and a second side wall of the side walls.

16. The solid oxide fuel cell of claim 15, wherein the flow path extending unit comprises a first partition wall attached to and extending from the first side wall in a direction toward the second side wall and a second partition wall attached to and extending from the second side wall in a direction toward the first side wall, wherein the first partition wall is spaced from the second partition wall in a direction perpendicular to the partition walls.

17. The solid oxide fuel cell of claim 14, further comprising a perforated plate in the cavity, wherein the perforated plate has a plurality of openings configured to allow the fluid to flow therethrough.

18. The solid oxide fuel cell of claim 17, wherein the diameters of the plurality of openings of the perforated plate vary with increasing distance of the plurality of openings from the outlet side of the flow path extending unit.

19. The solid oxide fuel cell of claim 17, wherein the diameters of the plurality of openings increase or decrease along the length of the flow path.

20. The solid oxide fuel cell of claim 17, wherein the plurality of openings are configured to provide a substantially uniform flow of fluid in the cavity.

21. The solid oxide fuel cell of claim 17, further comprising a plurality of guide tubes, wherein each of the plurality of guide tubes is connected to a respective one of the plurality of openings of the perforated plate.

22. The solid oxide fuel cell of claim 14, further comprising a blocking unit adjacent to the first opening, wherein the blocking unit is configured to divert fluid flowing through the first opening into the flow path.
